(19) United States
(12) Patent Application Publication
(10) Pub. No.: US 2004/0225743 A1
(43) Pub. Date: Nov. 11, 2004

(54) Streaming media creation tool

(76) Inventors: Guy Dwayne Huggins, Kennedale, TX (US); David Allen Kopaniky, Garland, TX (US)

Correspondence Address: VINSON & ELKINS L.L.P., 1001 FANNIN STREET, 2300 FIRST CITY TOWER, HOUSTON, TX, 77002-6760, US

(21) Appl. No.: 10/429,322

(22) Filed: May 5, 2003

(51) Int. Cl. G06F 15/16

(52) U.S. Cl. 709/231

(57) ABSTRACT

The invention is directed to a creation tool and methods for manipulating streaming media presentations. A streaming media file may be created, broadcast, and/or archived. The media file may include various streaming media formats and slide transitions. Once captured or archived, the streaming media may be edited by interpreting the media and the location of the transition icons. The location of these transition icons may be further edited with a drag and drop interface and the file re-encoded. The creation tool and/or method may be used with various streaming media file formats including Windows Media™, Real Networks™, Quicktime™, and MPEG-4, among others. The creation tool may also permit the editing of streaming media files through cropping and trim features, among others.

### TECHNICAL FIELD OF THE INVENTION

This invention, in general, relates to the creation of streaming media. More specifically, the invention relates to a method and tool for creating streaming media presentations and distributing the streaming media presentations over an interconnected network.

### BACKGROUND OF THE INVENTION

With the development of interconnected networks, streaming media offers the opportunity to make presentations across these interconnected networks. Streaming media presentations provide for greater communication between individuals or groups. Streaming media may also be used for training and other on-demand presentations. In addition, the streaming media presentations provide a cost-effective alternative to travel. However, many streaming media creation tools and methods lack intuitive and easy-to-use interfaces for users. Furthermore, typical streaming media creation tools are not integrated with other streaming media components such as back-end delivery, managements, and caching tools, among others. Therefore, these tools lack built-in methods for management and delivery of content.

Several typical encoders for streaming media offer the capability of encoding slide transitions or image swaps in conjunction with streaming video and/or audio. The typical creation tool may utilize the streaming media format by encoding into the streaming media file slide and image changes as the streaming video or audio is created. However, these tools typically do not permit the simple and intuitive repositioning of these transition indicators or image changes.

In addition, these typical creation tools typically lack media editing tools. As presentations are archived or captured for on-demand presentations, the content creator is left without the ability to edit the media file. As such, pauses or mistakes may be left in the final product.

Furthermore, typical content creation tools lack integration with other streaming media components. These tools do not communicate with streaming media managers and servers. As a result, the network may suffer from inappropriate traffic. For example, the creation tool may utilize a high bandwidth format and quality which taxes the network structure.

As such, typical creation tools suffer deficiencies in presentation editing and media management. Many other problems and disadvantages of the prior art will become apparent to one skilled in the art after comparing such prior art with the present invention as described herein.

### SUMMARY OF THE INVENTION

Aspects of the invention are found in a multimedia creation tool and interface. The creation tool includes manipulatory transition icons representing slide transitions or image swaps located on a timeline. The icons may be moved relative to the timeline using a graphic user interface. The timeline may be associated with a streaming media file such as a video or audio file. In addition, a slidable icon may be associated with the streaming media timeline. In conjunction with the slidable icon and a trim button, the streaming media file may be cropped. The streaming media file may take various formats including Windows Media™ formats, Real Network™ formats, Quicktime™ formats, MPEG-4 formats, and open source formats, among others.

Additional aspects of invention are found in a method for creating a streaming media file. The method may include accessing a streaming media file, interpreting the streaming media file for display of its elements in a creation tool interface, manipulating the elements such as transition indicators, and encoding the manipulated streaming media file into a desired format. The interpreted elements may be displayed in an interface that is accessible through a graphic user interface and may permit the cropping of the streaming media and/or, manipulation of timing indicators. The format may include Windows Media™ formats, Real Networks™ formats, Quicktime™ formats, and MPEG formats, among others. The streaming media files may be accessed from a management server, video-on-demand server, archive server, cache, branched servers, and local servers, among others.

Further aspects of the invention are found in an integrated creation tool. The integrated creation tool includes communications methods for communicating with a management server and software system. In addition, the integrated creation tool includes communications methods for communicating with a distribution server and software.

As such, aspects of a creation tool for streaming media are described herein. Other aspects, advantages and novel features of the present invention will become apparent from the detailed description of the invention when considered in conjunction with the accompanying drawings.

### BRIEF DESCRIPTION OF THE DRAWINGS

For a more complete understanding of the present invention and advantages thereof, reference is now made to the following description taken in conjunction with the accompanying drawings in which like reference numbers indicate like features and wherein:

FIGS. 1, 2, 3 and 4 are schematic diagrams depicting exemplary embodiments of a network for use by the invention;

FIG. 5 is a schematic block diagram depicting an exemplary embodiment of a creation device, according to the invention;

FIGS. 6-18B are pictorials representing exemplary embodiments of a creation tool interface, according to the invention; and

FIGS. 19-22 are block flow diagrams depicting exemplary methods, according to the invention.

### DETAILED DESCRIPTION OF THE INVENTION

Various network architectures have been used to provide streaming media presentation functionality. Simple point-to-point transfer of the streaming media may be used for presentations between two people. However, more complex network structures are typically used for presentations from one person to many.

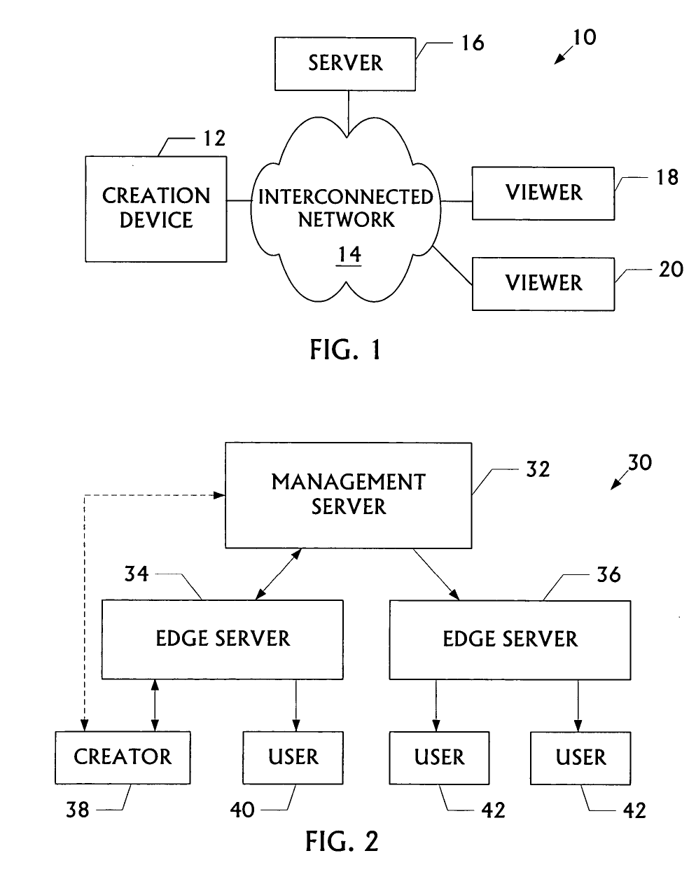

FIG. 1 is an exemplary embodiment 10 of a network. A media creation device 12 is connected to an interconnected network 14. Through the interconnected network 14, the creation device 12 may communicate with a server 16 and/or viewers 18 and 20. In one embodiment, the creation device 12 streams files to the server 16. The server 16 then broadcasts the media stream to the viewers 18 and 20.

The creation device 12 may take various forms including desktop computers, laptop computers, notebook computers, tablet computers, smart devices, and PDAs, among other networked computation circuitry. The server may take the form of a networked computational circuitry with media serving capabilities. The viewers 18 and 20 may take various forms including desktop computers, laptop computers, notebook computers, tablet computers, smart devices, and PDAs, among other networked computation circuitry. The interconnected network may take various forms include wireless and hardwired networks that communicate using protocols such as TCP/IP and Ethernet. In addition, communications may follow protocols such as HTTP, Microsoft Media Server Protocol (MMSP), Real Time Streaming Protocol (RTSP), FTP, SMTP, and SNMP, among others.

FIG. 2 depicts another exemplary embodiment of a network 30. The network 30 has a management server 32 coupled to edge servers 34 and 36. The edge servers 34 and 36 may, for example, be servers closer to access points in a network or branch offices within an intranet. The creation device 38 may communicate with the management server 32 and/or the edge server 34. The management server 32 or edge server 34 may then broadcast a presentation. For example, the creation device 38 may stream a media file to the edge server 34. The edge server 34 may stream the media file to the management server 32. The management server 32 may then stream the file to edge server 36 for distribution to users 42. In addition, the edge server 34 may stream the media to user 40.

In another exemplary embodiment, the creation device 38 may exchange control data, slides, images, or archived presentations with the management server 32. The management server 32 may then distribute the data, slides, images, and archived presentations to the edge servers 34 and 36. If the creation device 38 were on a network without an edge server 34, the creation device 38 may stream media presentations to the management server 32. However, various network communications paths may be envisioned.

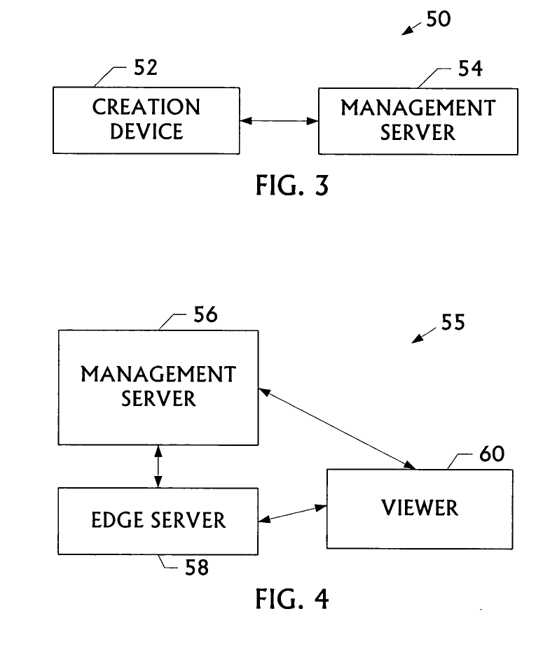

FIG. 3 depicts a communication and network 50 between a creation device 52 and a management server 54. The creation device 52 may establish a channel or broadcast settings with a management server 54. The channel and settings may include the name of the file, quality, bit rate, distribution permissions, start times, and expiration times, among others. The creation device 52 may stream the media to an edge server or the management server 54. Then, the management server 54 may deliver the file to edge servers and users within the network.

In one example, a user may create a presentation with a creation tool. The presentation may consist of a set of slides and an audio/video stream from a video camera. The creation tool may upload the slide images to the management server. Then, the creation tool may begin the broadcast. The broadcast may be streamed to an edge server or the management server. The management server may broadcast the presentation to users on other edge nodes. During the presentation, the user may periodically transition between slide images. These transitions may be encoded in the media stream and mimicked on viewer machines.

The creation tool may simultaneously archive the media file and presentation. Later, the creation tool may access and edit the archived media. For example, the creation tool may interpret a media file and display image transitions in a drag and drop graphical user interface. This archived and edited file may then be uploaded to the management server for staging on-demand presentations. However, the creation tool may upload the file to the edge server, management server, or another server. Further the edge server, management server, or another server may act to archive the presentation.

FIG. 4 depicts an exemplary network and communication 55 between the management server 56, the edge server 58 and the viewer 60. The viewer 60 may request a media stream from a management sever 56. The management server 56 may respond with a reference to an edge server 58. The edge server 58 may determine whether it has the requested media. If it does not, the edge server 58 may acquire a media stream from the management server 56. Then, the edge server 58 may stream the media to the viewer 60.

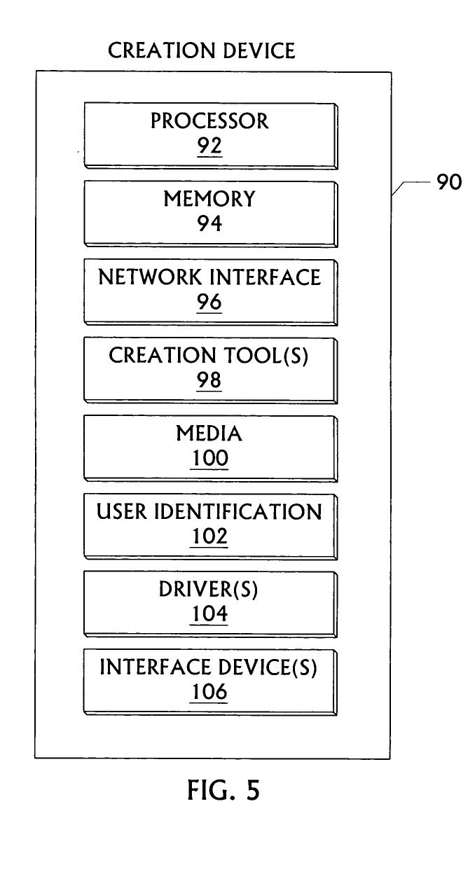

FIG. 5 is a block diagram depicting an exemplary creation device for streaming media files. The creation device 90 includes a processor 92, memory 94, network interfaces 96, creation tools 98, media 100, user identification 102, drivers 104, and input devices 106, among others. However, each of these elements may or may not be included together, separately, or in various combinations, among others.

The processor 92 and memory 94 function together to provide for the interpretation of instructions, software, inputs, and outputs, among others. Processor 92 may take various forms including various microprocessors and computational circuitry. The memory 94 may take various forms including RAM, ROM, flash memory, hard drives, CD ROM, CD-R, CD-RW, DVD, DVD-R, DVD-RW, floppy drives, and network drives, among others.

The network interfaces may take various forms, including those that communicate with such protocols as Ethernet, TCP/IP, and UDP, among others. Further, the network interface may permit communication using HTTP, MMSP, RTSP, FTP, SMTP, and SNMP, among others. The network interfaces may be used to provide access to remote multimedia servers, storage devices, archiving servers, management servers, edge servers, and remote users, among others.

The creation tools 98, media 100, user identification 102, and drivers 104 may be stored or incorporated into various memory components 94 of the system and interpreted or accessed by the processor 92 to provide the functionality and interfaces described below, among others. The creation tools 98 may be used to establish communication through the network interfaces 96 with a multimedia server, archive system, management server, edge server, or end viewer, among others. The creation tool. 98 may establish the settings and format for data transfer for streaming media. The creation tool, along with the interface devices 106 and media 100, can be used to create a streaming media file or to stream media to a remote server or user.

The media 100 may include audio files, video files, presentation files, slides, images, archived files, and other multimedia formats. For example, the creation tool may be used to capture and create streaming media files such as Windows Media™, Real Networks™, Quicktime™, MPEG-4, and other media formats. The media may also follow various formats such as PowerPoint™, JPEG, TIFF, GIF, PNG, BMP, WAV, MPEG, and AU, among others.

The creation tools 98 may use the user identification 102 or a creation device identification to establish parameters associated with access to preexisting or archived presentations, and settings associated with the transfer of data. For example, the user identification may be used to limit access to a given subset of available presentations. The user identification and/or network location may be used to limit streaming media broadcasts to formats, bit rates, and qualities that will not tax the network between the creation device and a receiving device.

The drivers 104 may include programs for interpreting input from interface devices 106, developing output to interface devices 106, encoding multimedia files, interpreting multimedia files, and controlling network activity, among others. The drivers may, for example, include encoders for Windows Media™, Real Networks™, Quicktime™, audio, video, and MPEG-4, among others. The drivers may also include instructions for interpreting input from graphical input devices, touch screens, a mouse, and tablets, among others. The drivers 104 may take various forms.

The system may stream media in multiple formats or at multiple bit rates. In one implementation, a ghost driver may be used to capture and encode two streaming media files. The two files may differ in quality or format.

The creation tools 98 may also function to interpret archived streaming media files and present those archived streaming media files in a timeline format with icons indicating the temporal location of image transition events and/or media transitions. The creation tool may permit manipulation of these icons to alter the temporal location of an image transition event. An icon may also represent the location within the streaming media file associated with a representation of that file in the interface. In conjunction with the location indicator, a trim button may be used to crop the multimedia file from either the end or the beginning.

The creation tools 98 may then be used to re-encode the multimedia file and store the encoded multimedia file on a remote server with a remote user or an archive, among others.

The interface devices 106 may take various forms. These forms may include microphones, cameras, key boards, mice, touch screens, video monitors, various displays, and tablets, among others. These devices 106 may facilitate the creation of a display and manipulation of a graphical user interface.

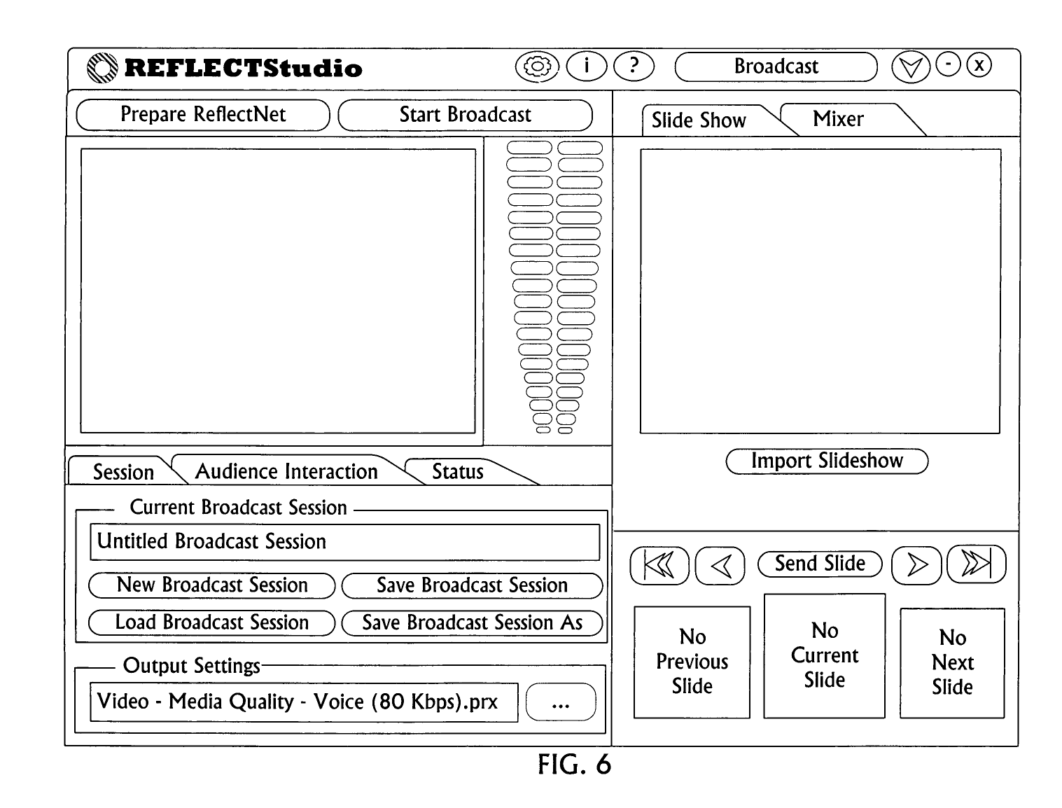

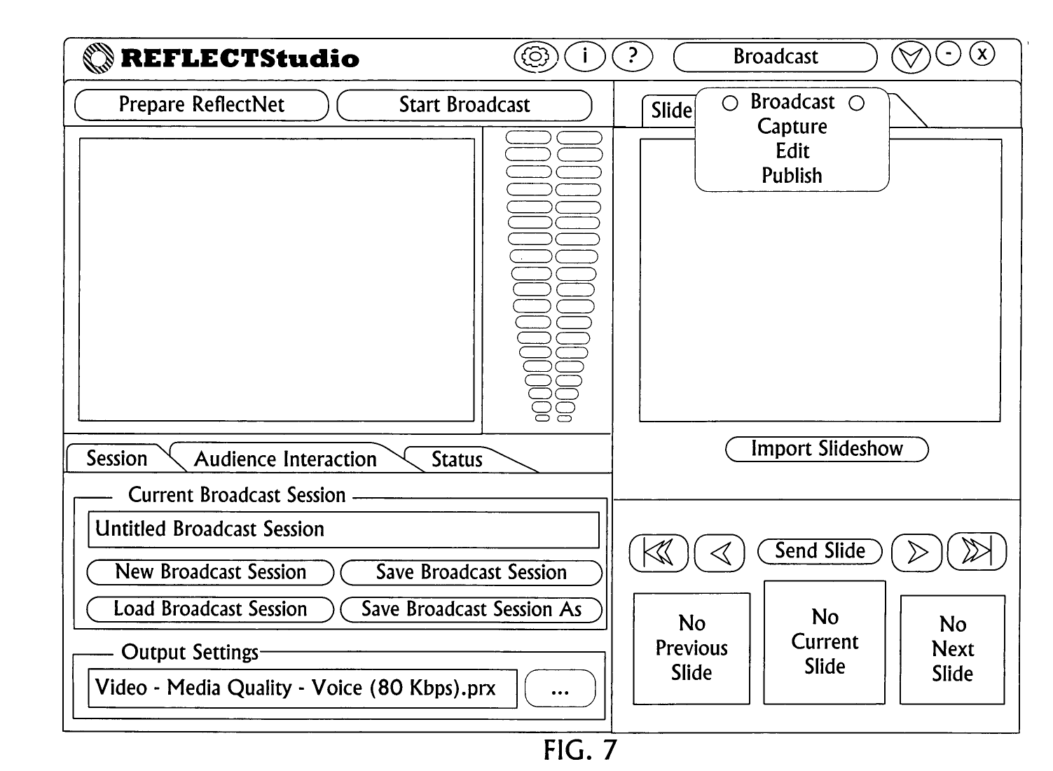

FIGS. 6-18 are pictorials depicting exemplary interfaces of a creation tool. FIG. 6 depicts the exemplary interface in a broadcast mode, as indicated by the word broadcast in the upper right hand corner. The interface may have a variety of properties, information, and help buttons across the top. Alternately, the interface may have a variety of pull down menus, buttons and checkboxes providing various functionalities. For example, the mode of the interface may be changed through a pull down menu as seen in FIG. 7. This exemplary interface has several modes including broadcast, capture, edit, and publish. However, the broadcast and capture modes may be combined.

In the broadcast mode as seen in FIG. 6, the exemplary interface has a variety of features. In the upper left-corner is a logo, herein “Reflect Studio.” Below the logo are two buttons: “Prepare Reflectnet” and “Start Broadcast.” The “Prepare Reflectnet” button may for example prompt the user for input and establish communication with a network server, management server, edge server, or publishing point. The “Start Broadcast” button may also prompt the user for information and/or facilitate the transfer of broadcast data to the publishing point or server. For example, these buttons may be used to establish communication with a management server, upload slide image files to the management server, and begin the capture and transfer of audio/video media to an edge server as directed by the management server.

Below the buttons is a display area, which may be used to display the streaming media data as it is sent or, depending upon the mode, media data which may be included in the presentation.

Below this display area is a set of tabs. In this case, the tabs have the titles “Session”, “Audience Interaction”, and “Status”. The “Session” tab provides a variety of buttons and access to menus for establishing a broadcast session and saving that broadcast session locally, at a publishing point, or on a server. The “Audience Interaction” tab permits interaction with audience questions. The “Status” tab depicts a variety of buttons, icons, and charts or graphics showing the status of various aspects of the system. Each of these tabs are explained in more detail in later figures.

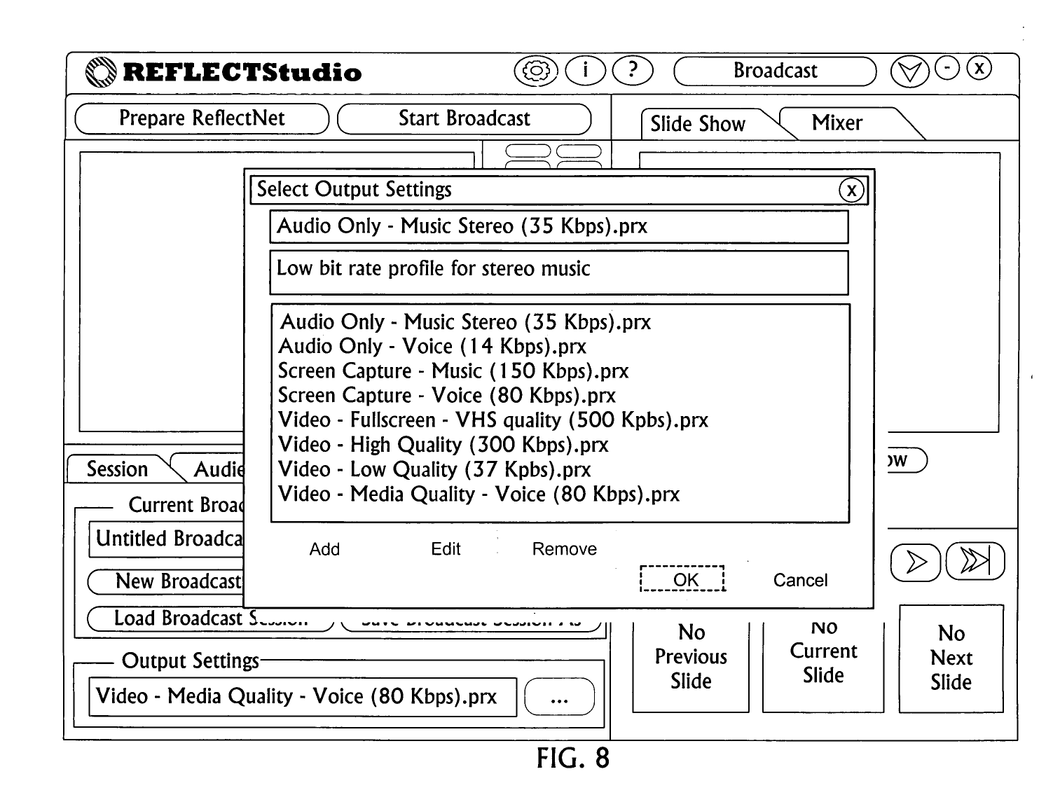

In the “Session” tab of this example, buttons are shown that permit the establishment of a “new broadcast session”, “loading a broadcast session”, “saving a broadcast session”, and “saving a broadcast session as”. These buttons establish broadcast settings and parameters and function to permit storage of these session data files on the creation device. One exemplary setting may be the output setting. FIG. 8 depicts the selection menu for the output setting. For example, a given broadcast may be communicated with the server in a variety of formats, audio only, screen capture, and video, with a variety of associated bit rates and quality. Selection of the format and quality may be limited by permissions associated with a user identification or network location. For example, 500 Kbps video may tax a connection between a remote office and a management server. As such, users at the remote office may be provided a subset of bit rates and media quality that conform to the network capacity.

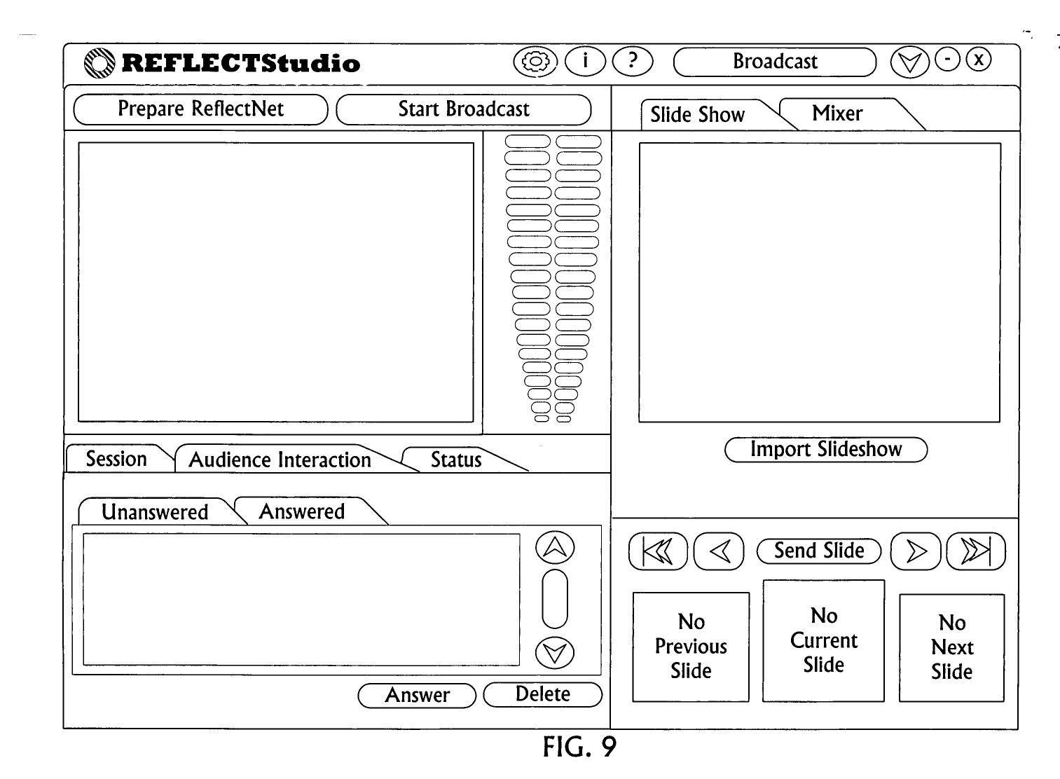

As is seen in FIG. 9, the “Audience Interaction” tab depicts another set of tabs, unanswered and answered, along with buttons for answering, deleting and scrolling through the listed questions. This tab permits the broadcaster to respond to questions typed by members of the audience. The questions typed by those members appear in the unanswered tab. As questions are answered, the presenter may select the answered button, moving those questions into the answered tab. Alternately, the user may delete the questions or scroll through the questions as needed.

In an alternate embodiment, the audience tab may be replaced with a viewer. The viewer may download data from the management server or publishing point. For example, the viewer may download an HTML document. The data may be questions from viewers, prompts, speech notes, and teleprompter comments, among others.

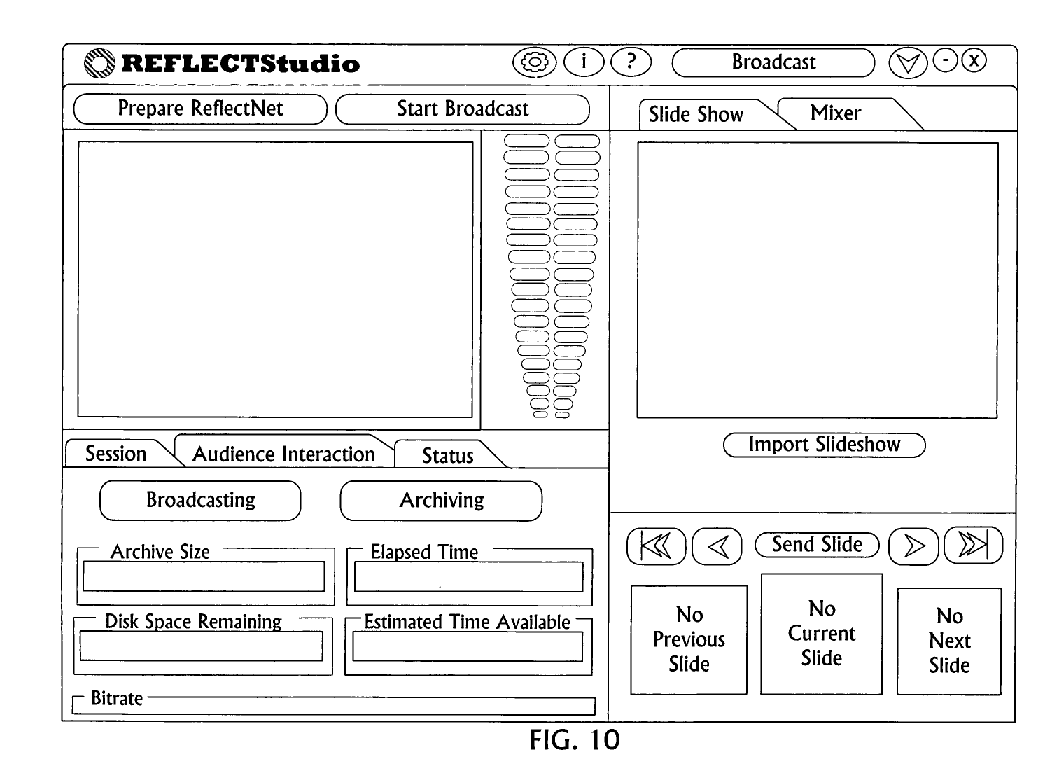

The “Status” tab may be seen in FIG. 10. In this exemplary embodiment, the “Status” tab depicts a broadcasting icon and archiving icon, which may be illuminated depending upon whether the presentation is broadcast or is being archived. In addition, text boxes or graphical bars may be used to depict the archive size, elapsed time, disc space remaining, estimated time available, and the rate of transfer, among others. However, various graphical features and elements may be used to display data associated with the status of a broadcast.

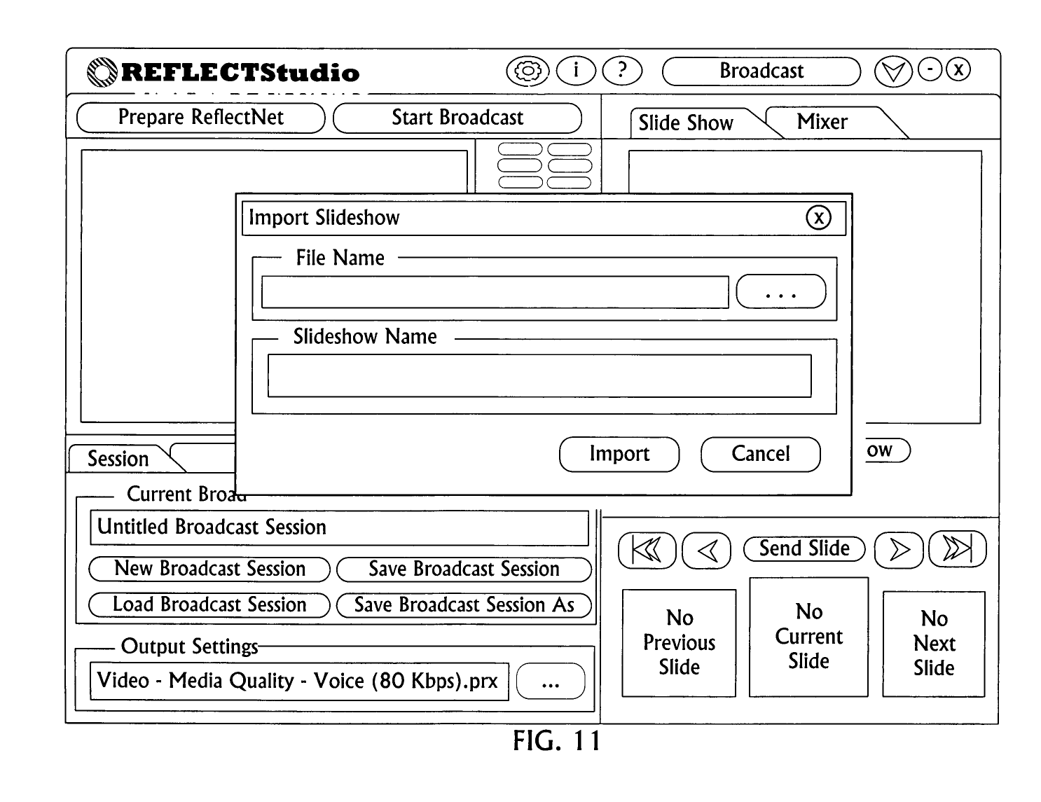

To the right side of the interface are two tabs indicating “Slide Show” and “Mixer.” The “Slide Show” tab permits one to import a slide show such as a PowerPoint file or other slide set. Selection of the import slide show button pops up the import slide show window as seen in FIG. 11. This window allows the selection of a file containing the slide show. Once the slide show is selected, the slides may appear in the window above the import slide show button and/or below the import slide show button. For example the window above may depict a current slide and the display below may depict a set of slides: the previous slide, current slide and next slide, along with controls for manipulating which slide is selected.

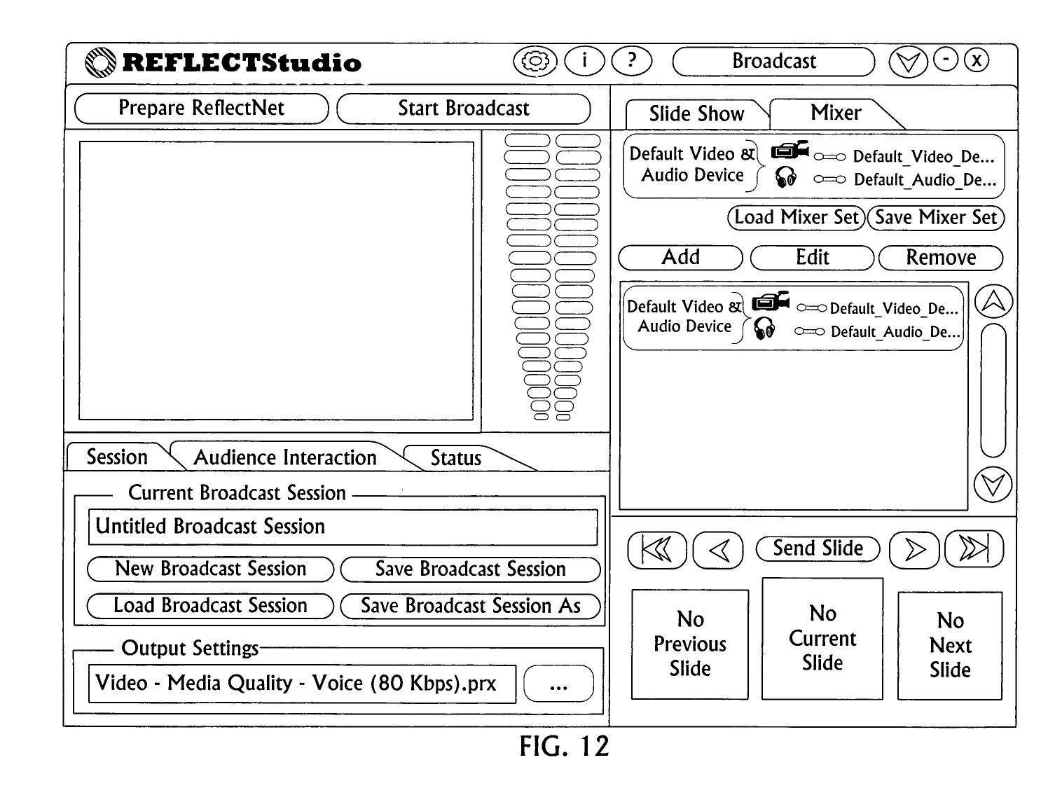

If the mixer tab is selected as seen in FIG. 12, a set of buttons and a menu is provided that permits the selection, loading, and editing of input from a variety of multimedia input devices, and media files, among others. For example, an item such as a default video or audio device may be placed in the menu. If selected, details about that item may be displayed above the buttons and below the mixer tab to show the current selected device.

If a set of devices are commonly used, the mixer set may be saved and then loaded as needed. Further, other devices may be added, edited, and removed as required. For example, in any given presentation, the user may have one or more cameras, one or more microphones, and one or more image, video, or audio files, which may be mixed with slides in order to create a multimedia presentation. However, one or more of these media may or may not be used. For example, a set of video files may be combined to make a broadcast. Alternately, a camera input and set of slides may be used to create a presentation. In another example, an audio stream and screen capture may be used to create a broadcast.

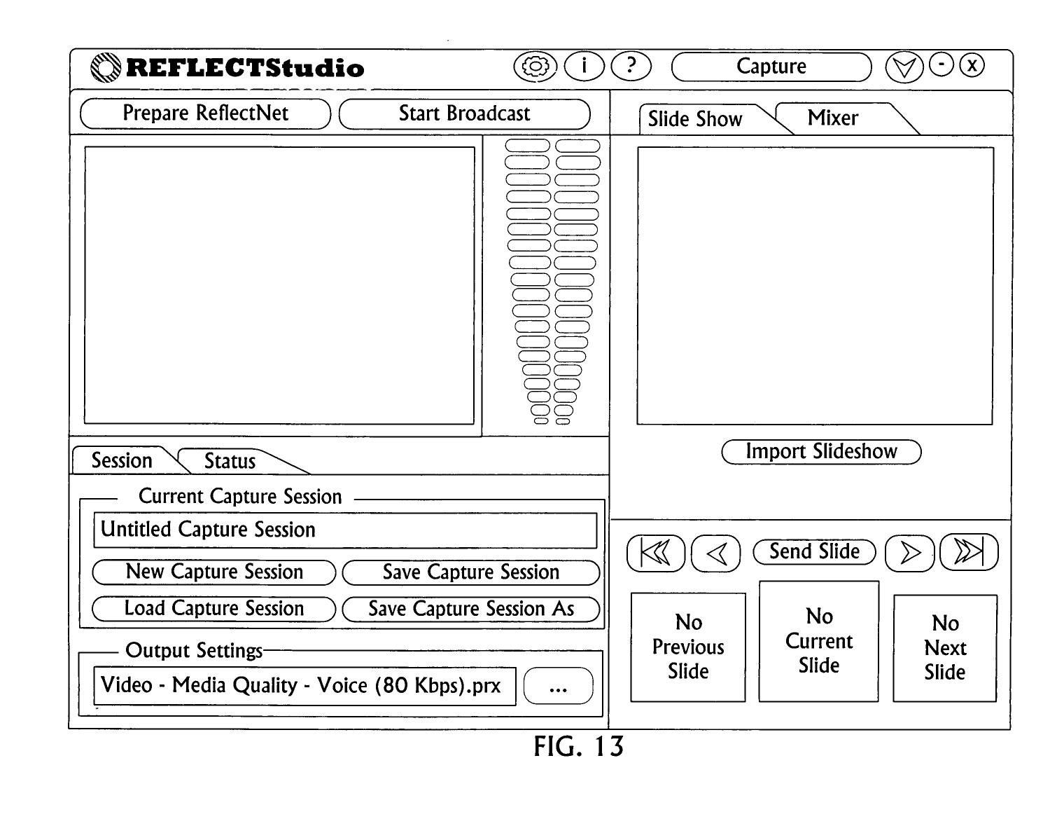

FIG. 13 depicts an alternate mode of the interface in which a presentation is captured and archived for future use. However, the capture mode may be combined with the broadcast mode in a “create mode.” The capturing may store the presentation on a local device. Alternately, the capture may store the presentation on an archiving server. The capture mode has a similar interface in which the start capture button begins the capture of a video stream seen in the window below the start capture button. The session and status tabs below the streaming media window permit the establishment of settings and display the status of the presentation. To the right, the slide show tab and mixer tab are used to import the slide show and intermix various streaming media into the captured presentation. The display to the bottom right side of the screen depicts the current slide, the previous slide and the next slide, along with buttons for manipulating which slide is currently selected. Together or in various combinations, these slides and media captured through the mixer may be combined to provide a presentation. However, the capture interface and broadcast interface may be combined.

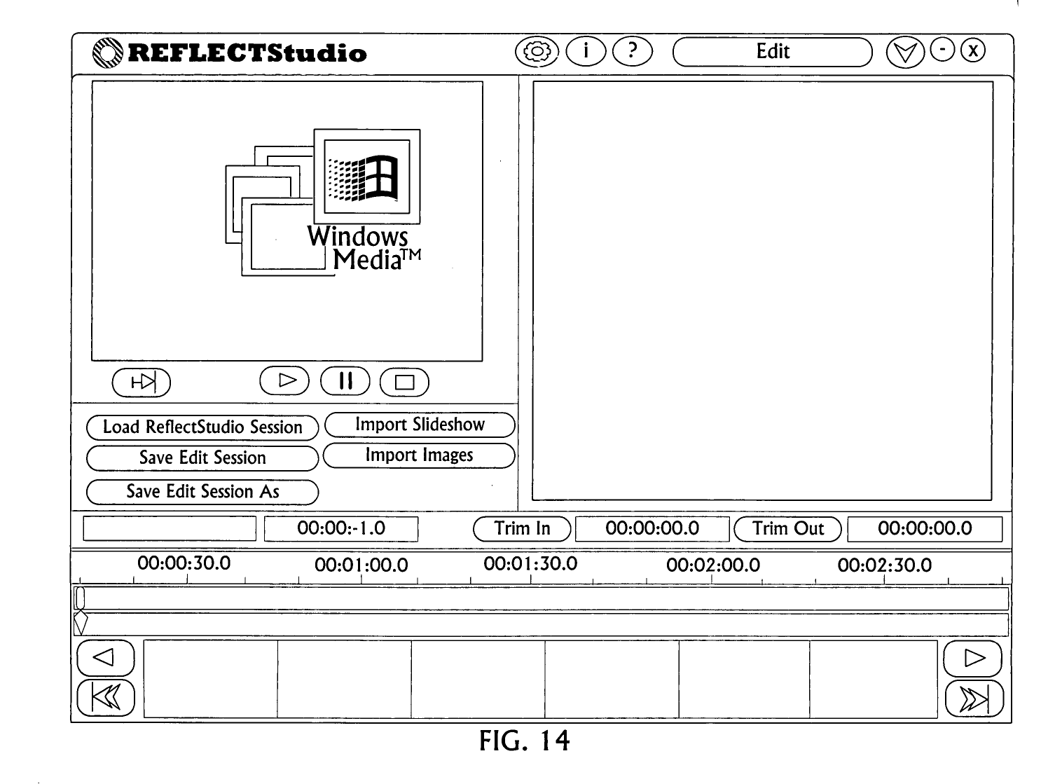

FIG. 14 depicts a further mode, the edit mode. The edit mode permits the editing of captured or archived presentations. The edit mode has a media window, in this case indicated as the Windows Media™ window. Below the media window is a set of controls for controlling the media flow. Below these controls are buttons permitting the loading of various sessions, importing of slide shows and images, and saving of edit sessions. To the right of the streaming media window is a large window, which may be used for displaying a current slide. Below these is a timeline with an icon depicting the location within the captured presentation represented in the media window. Below the timeline is a region for depicting slides that are available to the presentation.

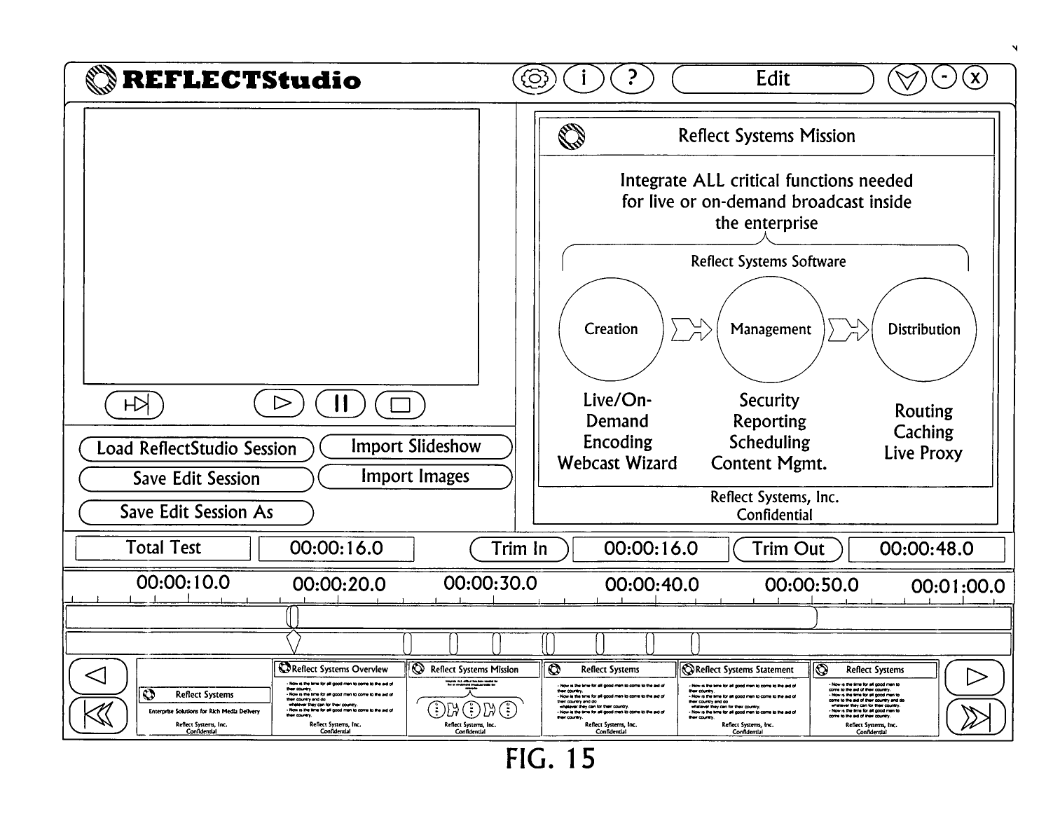

FIG. 15 depicts an exemplary presentation once loaded into the edit session. In this exemplary embodiment, the media is depicted as the darkened space below the timeline bracketed by two icons. Below the first icon to the left is an indicator of location within the presentation.

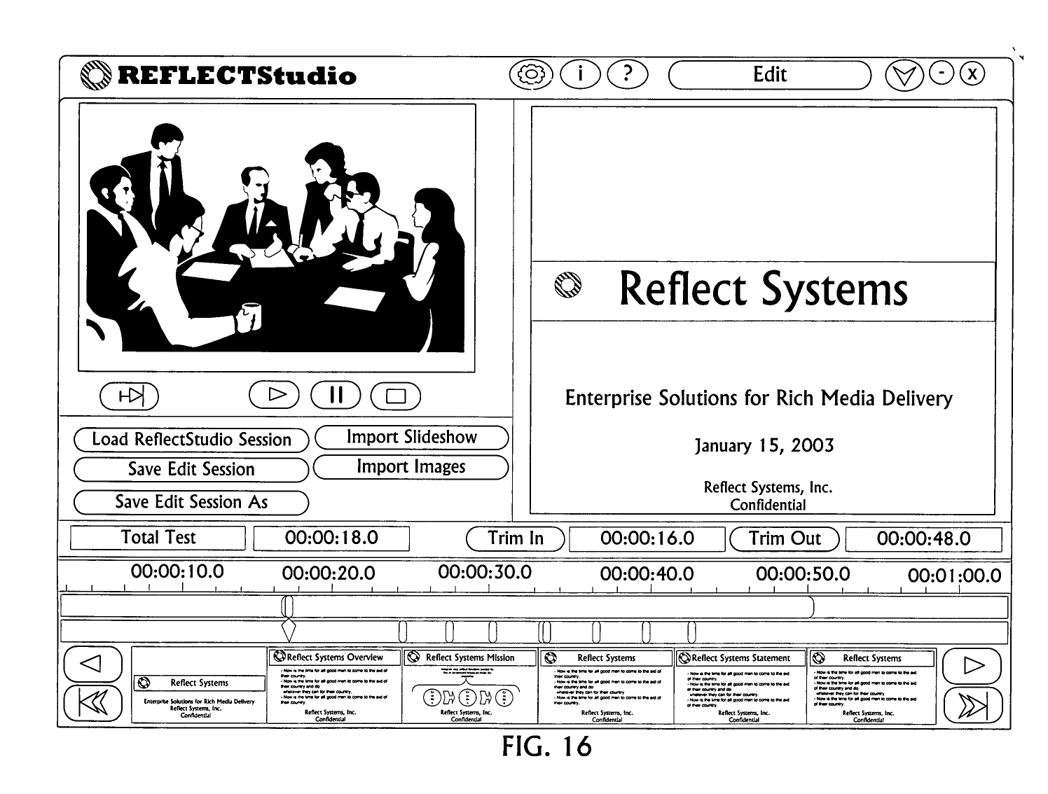

In a second row below the timeline are icons depicting the location of slide transitions. One of these transitions is highlighted resulting in the display of the slide associated with that transition in the upper right hand window. Various media formats permit the encoding of image or slide transitions within their streaming media. Once loaded, a session or media file is decoded to permit the interpretation and display of these transitions along a timeline as indicated below. This edit tool permits the manipulation of these transitions using an easy drag and drop interface. As is seen in FIG. 16, the transition markers may be rearranged from those seen in FIG. 15 to provide for an improved presentation.

Another feature of the system is the trim in and trim out buttons. These buttons may be used to trim unwanted streaming media from the presentation. Along the timeline, the end icons may be moved and video trimmed from the end based on the position of the icons. However, various instances or mechanisms may be envisaged in which streaming media may be edited from the middle.

In addition, mixer markers may be used to indicate transitions in mixed media. Examples of these markers may be seen in the time line. In this example, only one media stream was used. The mixer markers therefore mark the beginning and end of the presentation in the timeline. However, if other media files were intermixed into the presentation, these markers may be used to indicate the locations of the transitions. For example, a streaming presentation from a camera may be intermixed with a prerecorded video file. The markers would mark the boundaries between the camera output and the mixing of the video file. In another example, multiple cameras may be intermixed to provide for differing angles of view. The markers may mark the transitions between camera inputs.

Once edited, the session may be saved, archived or stored for use in an on-demand archive or for mixing in other presentations.

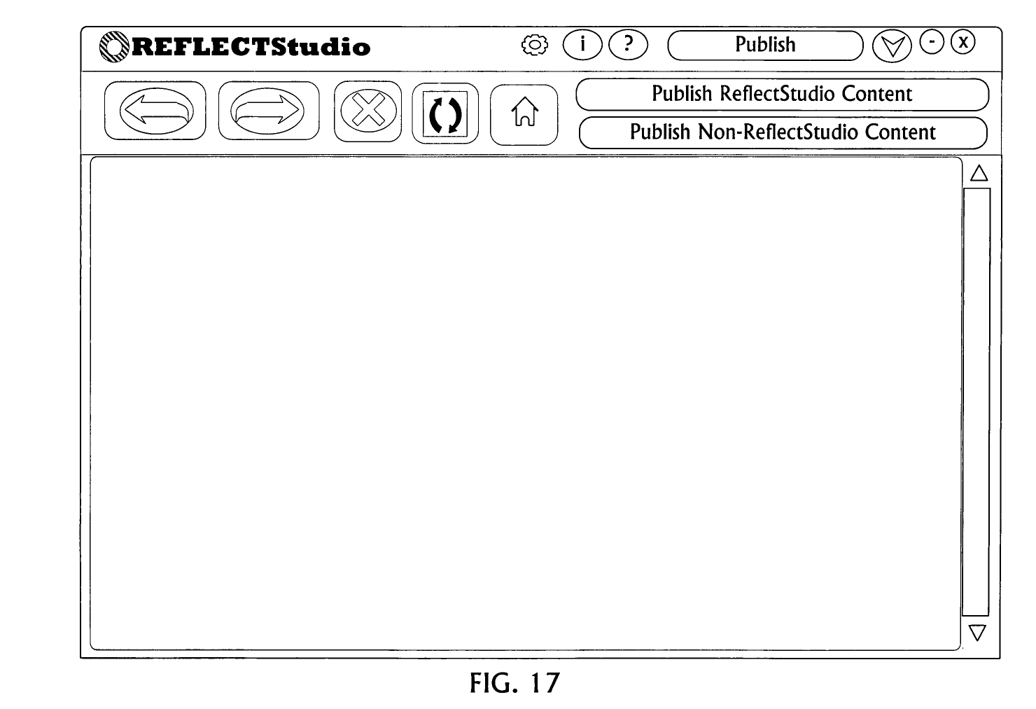

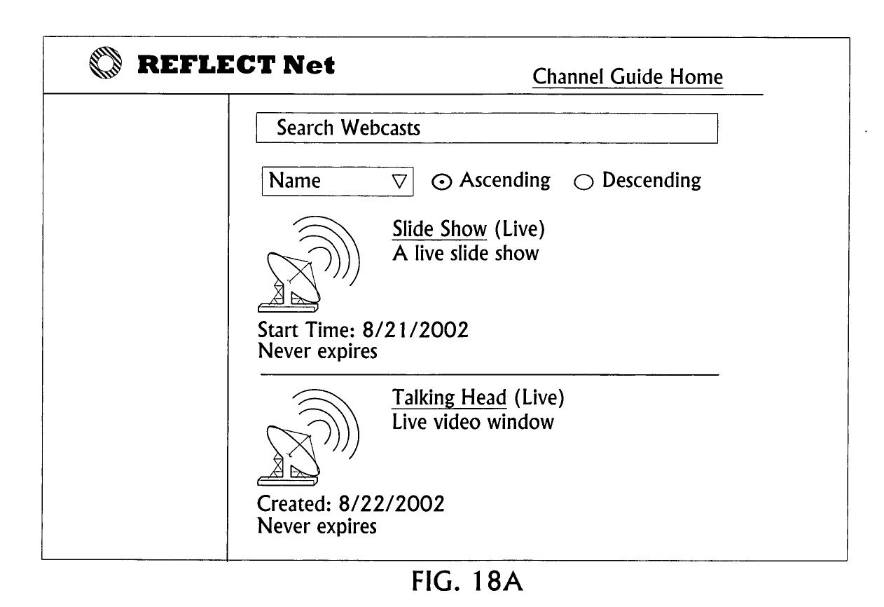

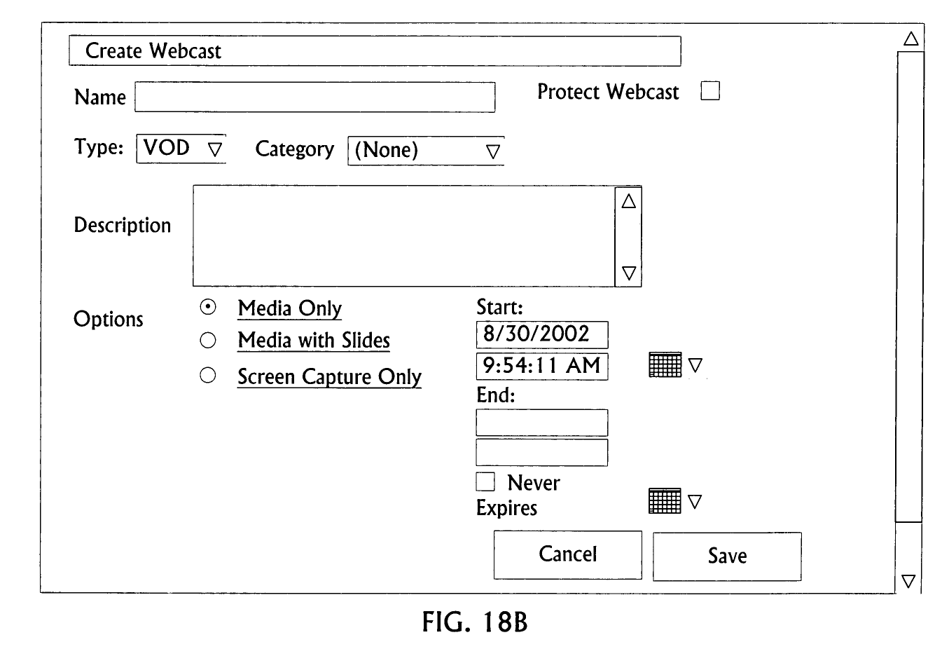

FIG. 17 depicts another mode, the publish mode. The publishing window depicts a window that may access the publishing server or management server. In this example, the publishing window acts much like a browser, communicating with the central server in an HTML format. FIG. 18A depicts an exemplary page in which a list of available shows broadcast or archived presentations is shown. FIG. 18B depicts a window for creating a channel or broadcast. However, a variety of screens may be available to manipulate the server and upload or download various broadcasts and managed broadcasts.

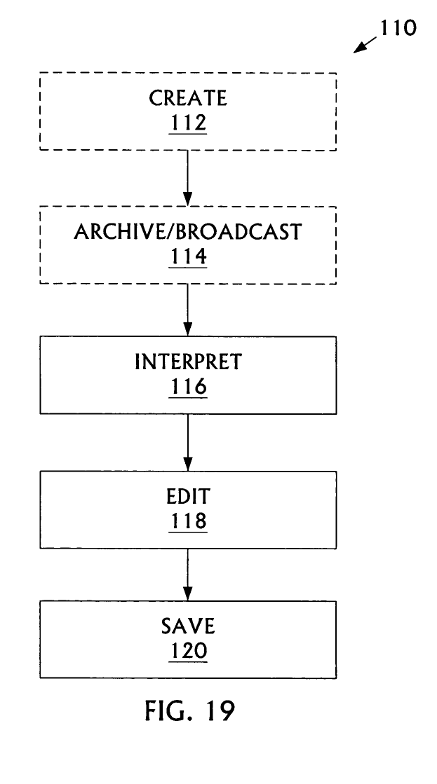

FIG. 19 depicts an exemplary method for use in the system. The method 110 may or may not include the steps of creating content as seen in a block 112 and archiving or broadcasting that content as seen in a block 114. For example, the system may be used to create a multimedia file or streaming media file such as a Windows Media™ file, containing streaming video and slide images with transition signals associated with slide transitions. This file may be broadcast and/or archived. Subsequently, the archive broadcast may be interpreted as seen in block 116. The interpretation may include the analysis of streaming media content to determine the location of image or slide transitions within the media presentation. This interpretation may result in the display of a timeline with associated slide transition icons. The user may then edit the location of these slide transition icons and, to some extent, the streaming media, as seen in block 118. For example, the user may utilize the drag and drop feature associated with the slide transition icons to more appropriately position transitions of slides. In another example, the user may crop the media file with a trim button. Subsequently, the user may save or archive the editing presentation, as seen in block 120. For example, the user may save the presentation to a local drive. Alternately, the user may encode the presentation and stage it on a publishing or management server.

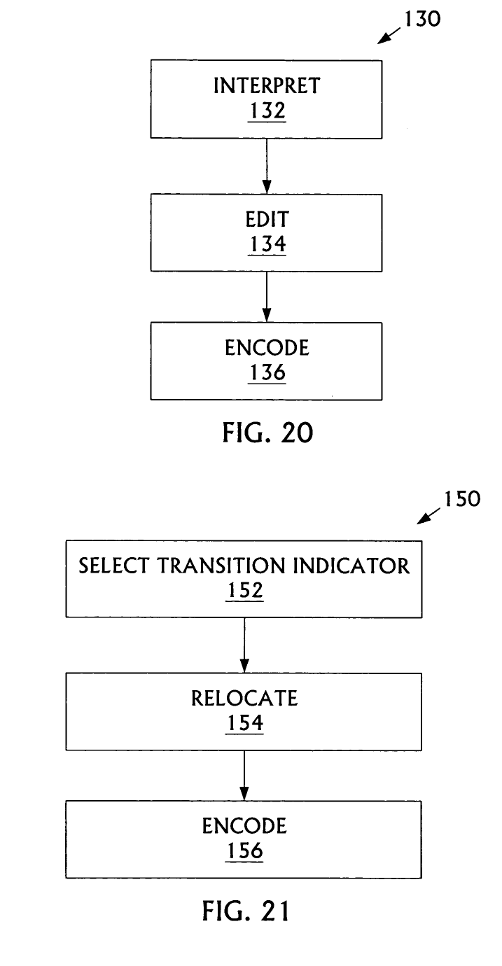

Various streaming media formats permit the inclusion of slide timing signals in the streaming media formats, including Windows Media™, Real Networks™, Quicktime™, and MPEG 4, among others. As seen in FIG. 20, a method would include the interpretation of these formats as seen in block 132 to provide for an interface that may be manipulated by a user. The user may then edit the transition signals and streaming media as seen in block 134. This may include manipulating the location of slide transitions along the media timeline. The media, with the edited timing signals, is then encoded as seen in a block 136 into a format. This format may be the same format as was interpreted in block 132 or a new format. For example, a Windows Media™ file may be interpreted, edited, and re-encoded.

The editing, as seen in FIGS. 19 and 20, may include the manipulation of an icon or transition indicator. FIG. 21 depicts a method of editing the content. Once the media file is interpreted and displayed, the transition icons may be selected as seen in a block 152. The icons may then be relocated, deleted, or added, as seen in a block 154 along the media timeline. The new locations may then be encoded as seen in a block 156 into a new media file.

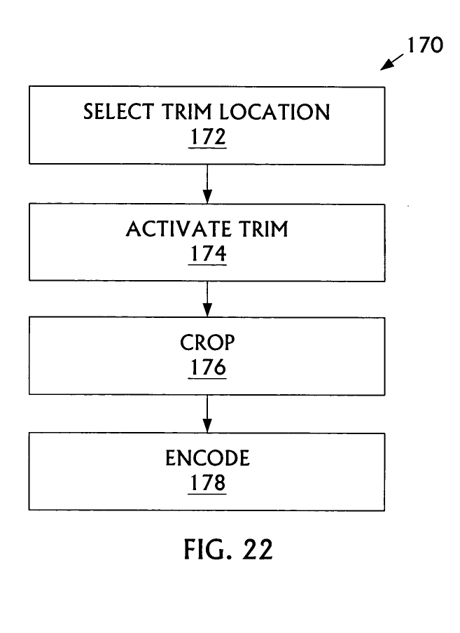

Another method which may be used in the editing of media presentations is seen in FIG. 22. The method 170 includes selecting a trim location as seen in 172. The trim location may be indicated by trim icons or icons indicating a location within a media timeline. A button indicating what section is to be trimmed may be activated as seen in block 174. The system may then crop media as seen in block 176 and the media may then be encoded as seen in block 178.

As such, a creation tool and method for creating streaming media is described. In view of the above detailed description of the present invention and associated drawings, other modifications and variations will now become apparent to those skilled in the art. It should also be apparent that such other modifications and variations may be effected without departing from the spirit and scope of the present invention.

What is claimed:

1. A creation tool for streaming media files comprising:
a means for accessing the streaming media file;
a means for interpreting the streaming media file and for displaying elements of the streaming media file in an interface that includes manipulatory transition icons wherein said icons may be moved using a graphic user interface that comprsies a timeline associated with the streaming media file with a slidable icon;
a means for encoding the manipulated streaming media file into a desired format; and
a means for communicating said manipulated streaming media files to a distribution server.

2. The creation tool of claim 1, wherein the streaming media files may take various formats including Windows Media™ formats, Real Network™ formats, Quicktime™ formats, MPEG-4 formats, and open source formats.

3. The creation tool of claim 1, further comprising a trim button that allows the streaming media file to be cropped.

4. The creation tool of claim 1, wherein the streaming media files may be accessed from a management server, video-on-demand server, archive server, cache, branched servers, or local servers.

5. A method of creating streaming media files comprising:
accessing the streaming media file;
interpreting the streaming media file;
displaying elements of the streaming media file in an interface that includes manipulatory transition icons wherein said icons may be moved using a graphic user interface that comprsies a timeline associated with the streaming media file with a slidable icon;
encoding the manipulated streaming media file into a desired format; and
communicating said manipulated streaming media files to a distribution server.

6. The method of claim 5, wherein the streaming media files may take various formats including Windows Media™ formats, Real Network™ formats, Quicktime™ formats, MPEG-4 formats, and open source formats.

7. The method of claim 5, wherein a trim button allows the streaming media file to be cropped.

8. The method of claim 5, wherein the streaming media files may be accessed from a management server, video-on-demand server, archive server, cache, branched servers, or local servers.
